(19) United States
(12) Patent Application Publication
(10) Pub. No.: US 2026/0128677 A1
(43) Pub. Date: May 7, 2026

(54) POWER CONVERTER WITH COUPLED INDUCTORS

(71) Applicant: Monolithic Power Systems, Inc., Kirkland, WA (US)

(72) Inventor: Ting Ge, San Jose, CA (US)

(21) Appl. No.: 19/343,030

(22) Filed: Sep. 29, 2025

Related U.S. Application Data
(60) Provisional application No. 63/716,564, filed on Nov. 5, 2024.

(51) Int. Cl. H02M 3/158; H01F 3/14; H01F 27/28; H02M 1/00; H02M 3/00

(52) U.S. Cl. CPC H02M 3/1586; H01F 3/14; H01F 27/2804; H02M 1/0064; H02M 3/003

(57) ABSTRACT

A power converter has an inductor assembly and two power dies. The inductor assembly has two windings that share a magnetic core to form coupled inductors. Each winding has a main body, a first portion and a second portion. The main body extends towards a top surface of the inductor assembly. The first portion extends to form a first end at a bottom surface of the inductor assembly. The second portion extends to form a second end at the bottom surface of the inductor assembly. Each power die comprises a pair of switches that form a switch node electrically connected to a corresponding winding. A partially overlapped region between the two windings determines a coupling coefficient between the coupled inductors.

### CROSS-REFERENCE TO RELATED APPLICATIONS

The present application claims the benefit of U.S. Provisional Application No. 63/716,564, filed on Nov. 5, 2024, which is incorporated herein by reference in its entirety.

### BACKGROUND OF THE INVENTION

### 1. Field of the Invention

The present invention generally relates to electrical components, and more particularly but not exclusively relates to power converter.

### 2. Description of Related Art

Inductors are widely used in various electrical circuits, such as filters and power converters. As a particular example, in a power converter, a single output inductor may be used to couple a switch node to an output node of the power converter. Additionally, coupled inductors may be used to couple together the output phases of a multiphase power converter. A power converter, as known in the art, converts an input power to an output power, providing a load with required voltage and current. Multiphase power converters which comprise a plurality of paralleled power stages operating out of phase, offer several advantages, including lower output ripple voltage, better transient performance, and reduced ripple-current-rating requirements for input capacitors.

Coupled inductors have been widely used in power converters. These inductors are designed with symmetric windings and opposite current directions to realize an inverse coupling coefficient.

### SUMMARY OF THE INVENTION

In one embodiment, a power converter comprises an inductor assembly and two power dies. The inductor assembly has two windings that share a magnetic core to form coupled inductors. Each winding has a main body extending towards a top surface of the inductor assembly, a first portion extending to form a first end at a bottom surface of the inductor assembly, and a second portion extending to form a second end at the bottom surface of the inductor assembly. Each of the power dies comprises a pair of switches that form a switch node electrically connected to the first end of a corresponding winding. The second end of the corresponding winding is electrically connected to provide an output voltage. A partially overlapped region between the two windings determines a coupling coefficient between the coupled inductors.

In another embodiment, a power converter comprises an inductor assembly and two power dies. The inductor assembly has four windings that share a magnetic core to form coupled inductors. Each winding has a main body extending towards a top surface of the inductor assembly, a first portion extending to form a first end at a bottom surface of the inductor assembly, and a second portion extending to form a second end at the bottom surface of the inductor assembly. The power dies are placed on opposite sides of the inductor assembly. Each of the power dies comprises two pairs of switches. Each pair of switches forms a switch node that is electrically connected to the first end of a corresponding winding. The second end of the corresponding winding is electrically connected to provide an output voltage.

In yet another embodiment, an inductor assembly for a power converter comprises a magnetic core, and a first and second windings that share the magnetic core. Each of the first and second windings has a main body extending towards a top surface of the inductor assembly, a first portion extending to form a first end at a bottom surface of the inductor assembly, and a second portion extending to form a second end at the bottom surface of the inductor assembly. A first partially overlapped region between the first and second windings determines a coupling coefficient between the first and second windings.

These and other features of the present disclosure will be readily apparent to persons of ordinary skill in the art upon reading the entirety of this disclosure, which includes the accompanying drawings and claims.

### BRIEF DESCRIPTION OF DRAWINGS

The present invention can be further understood with reference to the following detailed description and the appended drawings, wherein like elements are provided with like reference numerals. These drawings are only for illustration purpose, thus may only show part of the devices and are not necessarily drawn to scale.

FIG. 1 illustrates a schematic diagram of a power converter 100 in accordance with an embodiment of the present invention.

FIG. 2 illustrates a perspective view of an inductor assembly 20.

FIG. 3A illustrates a perspective view of an inductor assembly 30 of FIG. 1 in accordance with an embodiment of the present invention.

FIG. 3B illustrates a perspective view of a winding 302 in accordance with an embodiment of the present invention.

FIG. 3C illustrates a perspective view of a winding 303 in accordance with an embodiment of the present invention.

FIG. 4 illustrates a front perspective view of the inductor assembly 30 of FIG. 3A in accordance with an embodiment of the present invention.

FIG. 5 illustrates a top view of the inductor assembly 30 of FIG. 3A in accordance with an embodiment of the present invention.

FIG. 6 illustrates a side view of the inductor assembly 30 of FIG. 3A in accordance with an embodiment of the present invention.

FIG. 7 illustrates a bottom view of the inductor assembly 30 of FIG. 3A in accordance with an embodiment of the present invention.

FIG. 8 illustrates a layout 80 of the power converter 100 of FIG. 1 in accordance with an embodiment of the present invention.

FIG. 9 illustrates a schematic diagram of a power converter 200 in accordance with an embodiment of the present invention.

FIG. 10 illustrates a perspective view of an inductor assembly 90 in accordance with an embodiment of the present invention.

FIG. 11 illustrates a front perspective view of the inductor assembly 90 of FIG. 9 in accordance with an embodiment of the present invention.

FIG. 12 illustrates a top perspective view of the inductor assembly 90 of FIG. 9 in accordance with an embodiment of the present invention.

FIG. 13 illustrates a side perspective view of the inductor assembly 90 of FIG. 9 in accordance with an embodiment of the present invention.

FIG. 14 illustrates a bottom view of the inductor assembly 90 of FIG. 9 in accordance with an embodiment of the present invention.

FIG. 15 illustrates inductance curves of the output inductors 220-1 and 220-2 in accordance with an embodiment of the present invention.

FIG. 16 illustrates a layout 160 of the power converter 200 of FIG. 9 in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

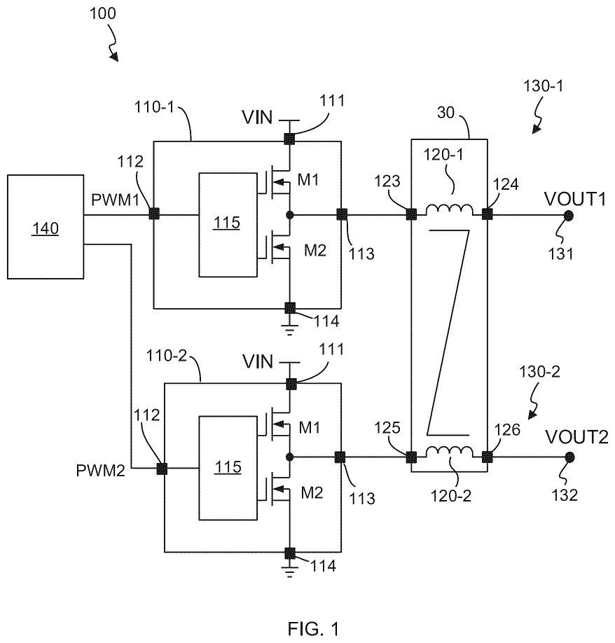

FIG. 1 illustrates a schematic diagram of a power converter 100 in accordance with an embodiment of the present invention. In the example of FIG. 1, the power converter 100 has two phase switching circuits 130 (i.e., 130-1, 130-2), with each phase switching circuit comprising an output inductor 120 (i.e., 120-1, 120-2), and a power die 110 (i.e., 110-1, 110-2). In the example of FIG. 1, each power die 110 includes a driver 115, a high-side switch M1 (e.g., MOS transistor), and a low-side switch M2 (e.g., MOS transistor). The driver 115 drives the high-side switch M1 and the low-side switch M2. Each power die 110 has an input node 111 configured to receive an input voltage VIN, a control node 112 configured to receive a switching control signal PWM (i.e., PWM1, PWM2), a switch node 113 formed by the pair of switches M1 and M2, and a reference node 114 electrically connected to a reference ground. Each phase of the switching circuits 130 receives the input voltage VIN to generate the output voltage VOUT (i.e., VOUT1, VOUT2), via the corresponding power die 110 and output inductor 120. The output voltages VOUT1-VOUT2 of the switching circuits 130-1 and 130-2 may be connected together and interleaved to generate a multiphase output voltage. For example, an output voltage node 131 and an output voltage node 132 may be connected together, with each switching circuit 130 providing a phase of a multiphase output voltage. In that example, the power converter 100 may include more additional switching circuits to add more phases. In the example of FIG. 1, each of the switching circuits 130 is a buck circuit. As can be appreciated, each of the switching circuits 130 may also be configured as boost circuit or other types of switching circuit depending on the application.

Furthermore, an inductor assembly 30 includes two windings to form the output inductors 120-1 and 120-2 respectively. A first winding that forms the output inductor 120-1 has a first end 123 electrically connected to the switch node 113 formed by the pair of switches M1 and M2 of the power die 110-1, and a second end 124 electrically connected to the output node 131 to provide the output voltage VOUT1. A second winding that forms the output inductor 120-2 has a first end 125 electrically connected to the switch node 113 formed by the pair of switches M1 and M2 of the power die 110-2, and a second end 126 electrically connected to the output node 132 to provide the output voltage VOUT2.

In one embodiment, the output inductors 120-1 and 120-2 are inversely coupled inductors that use a partially overlapped region, rather than a distance between windings, to determine coupling coefficient between the output inductors 120-1 and 120-2. The coupling coefficient can be easily adjusted by simply changing a size (e.g., a length) of the partially overlapped region.

A controller 140 generates the switching control signals PWM1, PWM2 to drive the power dies 110-1, 110-2 respectively, such that the output voltages VOUT1 and VOUT2 are maintained in regulation. Other circuits or components, such as input capacitors, output capacitors, sense circuits, are not shown for clarity of illustration.

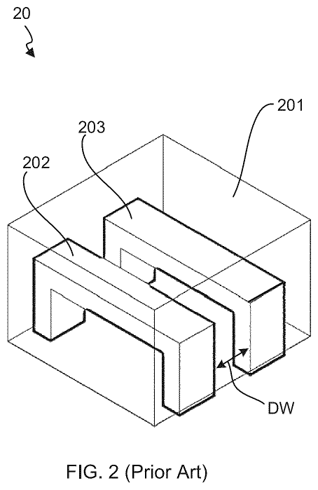

FIG. 2 illustrates a perspective view of an inductor assembly 20. The inductor assembly 20 includes symmetric windings 202-203 coupled together via a magnetic core 201. These windings can be used to form the output inductors 120-1 and 120-2 shown in FIG. 1, which are essential components of the power converter 100. To achieve inverse coupling coefficients, the windings 202-203 have opposite current directions. As shown in FIG. 2, the windings 202-203 are arranged in parallel (e.g., side by side), and the coupling requirement determines a distance DW between the windings 202-203. By changing the distance DW, the coupling coefficient can be fine-tuned to meet specific design needs. However, when footprint constraints exist, maintaining large distance DW between the windings 202-203 can become a significant challenge, which may limit the overall performance of the system.

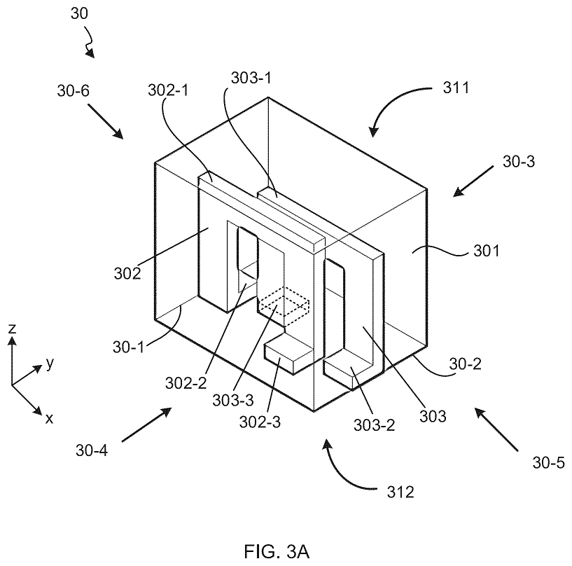

FIG. 3A illustrates a perspective view of the inductor assembly 30 of FIG. 1 in accordance with an embodiment of the present invention. The inductor assembly 30 has two windings 302 and 303 magnetically coupled together via a magnetic core 301. The winding 302 forms the output inductor 120-1, and the winding 303 forms the output inductor 120-2 shown in FIG. 1, which are essential components of the power converter 100.

A partially overlapped region is formed between the windings 302 and 303 in a direction parallel to a top surface 311 and a bottom surface 312 of the inductor assembly 30, and a coupling coefficient between the coupled inductors formed by the windings 302 and 303 is determined by the partially overlapped region. Particularly, main bodies 302-1 and 303-1 of the windings 302 and 303 arranged in parallel with each other and perpendicular to the top surface 311 and the bottom surface 312, are partially overlapped with each other, to create inverse coupling between the windings 302 and 303. For clarity, the terms “top” and “bottom” refer to the orientation relative to a substrate that supports the inductor assembly 30, such as a PCB or other substrate. In one embodiment, the main bodies 302-1 and 303-1 have an “n” shape, with each extending towards the top surface 311 of the inductor assembly 30.

The winding 302 further includes a portion 302-2 and a portion 302-3 at least partially exposed on the bottom surface 312 of the inductor assembly 30 and are connected by the main body 302-1. The portion 302-2 extends to form the first end 123 of the winding 302 on the bottom surface 312 of the inductor assembly 30, where it electrically connects to the switch node 113 of the power die 110-1 as shown in FIG. 1. The portion 302-3 extends to form the second end 124 of the winding 302 on the bottom surface 312, where it electrically connects to the output voltage node 131 to provide the output voltage VOUT1 as shown in FIG. 1. In one embodiment, the portion 302-2 extends towards a side surface 30-3 of the magnetic core 301, and the portion 302-3 extends towards a side surface 30-4 of the magnetic core 301, the side surface 30-3 is opposite to the side surface 30-4 along a y-axis.

Similarly, the winding 303 further includes a portion 303-2 and a portion 303-3 at least partially exposed on the bottom surface 312 of the inductor assembly 30 and are connected by the main body 303-1. The portion 303-2 extends to form the first end 125 of the winding 303 on the bottom surface 312 of the inductor assembly 30, where it electrically connects to the switch node 113 of the power die 110-2 as shown in FIG. 1. The portion 303-3 extends to form the second end 126 of the winding 303 on the bottom surface 312, where it electrically connects to the output voltage node 132 to provide the output voltage VOUT2 as shown in FIG. 1. In one embodiment, the portion 303-2 extends towards the side surface 30-4 of the magnetic core 301, and the portion 303-3 extends towards the side surface 30-3 of the magnetic core 301.

As illustrated in FIG. 3A, the portion 302-2 of the winding 302 is positioned near an edge 30-1 of the bottom surface 312, while the portion 302-3 is positioned farther away from the edge 30-1, e.g., in a middle region of the bottom surface 312. The portion 303-2 of the winding 303 is positioned near an edge 30-2, which is opposite the edge 30-1, and the portion 303-3 is positioned farther away from the edge 30-2, e.g., in the middle region of the bottom surface 312.

In one embodiment, the winding 302 is partially exposed on a side surface 30-6 of the magnetic core 301, the winding 303 is partially exposed on a side surface 30-5 of the magnetic core 301. The side surfaces 30-5 and 30-6 are opposite to each other along an x-axis. In one embodiment, the windings 302 and 303 could have the same length, width and height. The length (e.g., along the x-axis shown in FIG. 3A) of the windings 302 and 303 is smaller than that of the magnetic core 301. The height (e.g., along the z-axis shown in FIG. 3A) of the windings 302 and 303 could be same or smaller than that of the magnetic core 301.

Unlike conventional approaches that rely on adjusting the distance DW between symmetric windings to control the coupling coefficient, the present disclosure utilizes windings 302-303 that are offset from each other to partially overlap. A partially overlapped region between the winding 302 and the winding 303 determines the coupling coefficient between them. By utilizing this approach, a gap between the windings 302-303 (e.g., between the main bodies 302-1 and 303-1) can be designed to be as small as possible, reducing the size of the inductor assembly 30 and enabling more compact and efficient power converter designs. The present disclosure thus allows for a smaller footprint while still providing desired coupling coefficient, making it an attractive solution for a wide range of applications.

FIG. 3B illustrates a perspective view of the winding 302 in accordance with an embodiment of the present invention. FIG. 3C shows a perspective view illustrating the winding 303 in accordance with an embodiment of the present invention. In the example of FIGS. 3B and 3C, each of the windings 302-303 is one turn. The windings 302-303 may be flat copper wires with enamel coating.

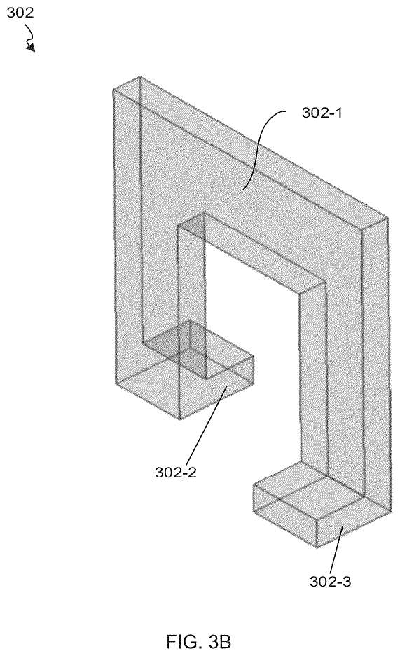

FIG. 4 illustrates a front view of the inductor assembly 30 of FIG. 3A in accordance with an embodiment of the present invention. To illustrate the current flow, a dotted line 41 shows a current flowing through the winding 302, e.g., flows from the first end 123 to the second end 124 of the winding 302. A dot-dash line 42 shows a current flowing through the winding 303, e.g., flows from the first end 125 to the second end 126 of the winding 303. In the partially overlapped region of the windings 302-303, the main bodies 302-1 and 303-1 are partially overlapped with each other to have inverse current flow, such that a flux generated by the windings 302-303 are reduced. A length DOL indicating the partially overlapped region of the windings 302-303 determines the coupling coefficient between them for optimal performance. Specifically, the longer the length DOL is, the larger the coupling coefficient; conversely, the shorter the length DOL is, the smaller the coupling coefficient.

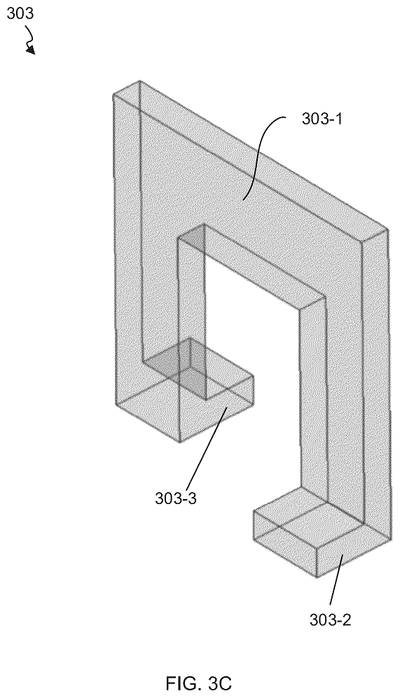

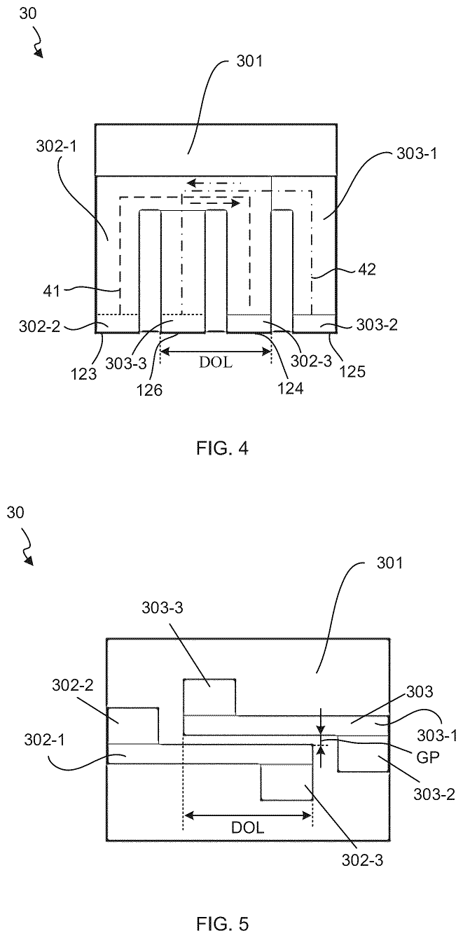

FIG. 5 illustrates a top view of the inductor assembly 30 of FIG. 3A in accordance with an embodiment of the present invention. FIG. 6 illustrates a side view of the inductor assembly 30 of FIG. 3A in accordance with an embodiment of the present invention. As shown in FIG. 5, due to the partially overlapped region between the windings 302 and 303, a gap (such as a distance) GP between the main bodies 302-1 and 303-1 can be designed as small as possible, reducing the size of the inductor assembly 30 while maintaining desired coupling coefficient. This enables more compact designs and improved overall system efficiency. In one example, the gap GP is a small distance less than 0.4 mm.

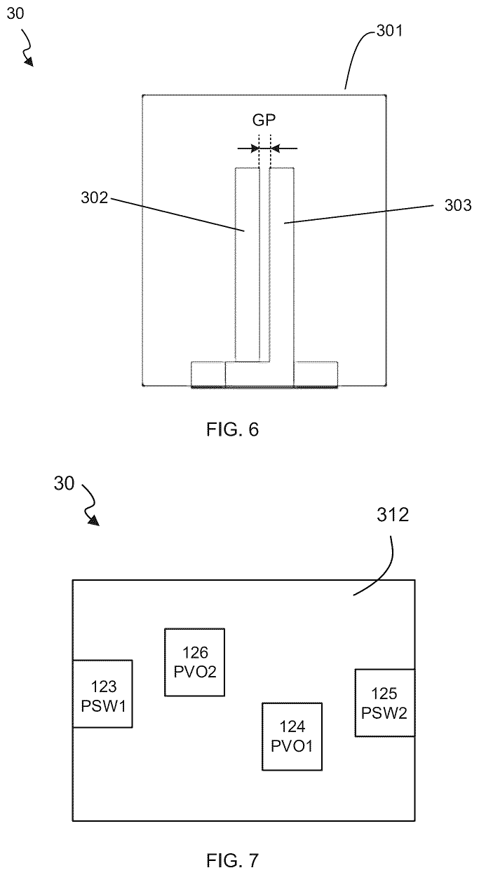

FIG. 7 illustrates a bottom view of the inductor assembly 30 of FIG. 3A in accordance with an embodiment of the present invention. In the example of FIG. 7, the ends 123-124 of the winding 302 and the ends 125-126 of the winding 303 are on the bottom surface 312 of the inductor assembly 30, playing a crucial role in facilitating current flow and power transmission. The first end 123 of the winding 302 forms or is electrically connected to a switching pad PSW1, which connects to the switch node 113 of the power die 110-1. The second end 124 of the winding 302 forms or is electrically connected to an output pad PVO1, which connects to the output voltage node 131 to provide the output voltage VOUT1. The first end 125 of the winding 303 forms or is electrically connected to a switching pad PSW2, which connects to the switch node 113 of the power die 110-2. The second end 126 of the winding 303 forms or is electrically connected to an output pad PVO2, which connects to the output voltage node 132 to provide the output voltage VOUT2.

As shown in FIG. 7, the output pads PVO1 and PVO2 are located in the middle region of the bottom surface 312 of the inductor assembly 30, and are not close to edges anymore, providing larger space for each pad and enhancing layout and soldering flexibility. In one embodiment, the output pads PVO1 and PVO2 can be electrically connected together by external interconnect or interconnect inside the inductor assembly 30 to make the power converter 100 as a dual-phase power converter. In another embodiment, the output pads PVO1 and PVO2 can be electrically disconnected from each other to make the power converter 100 work as two independent converters.

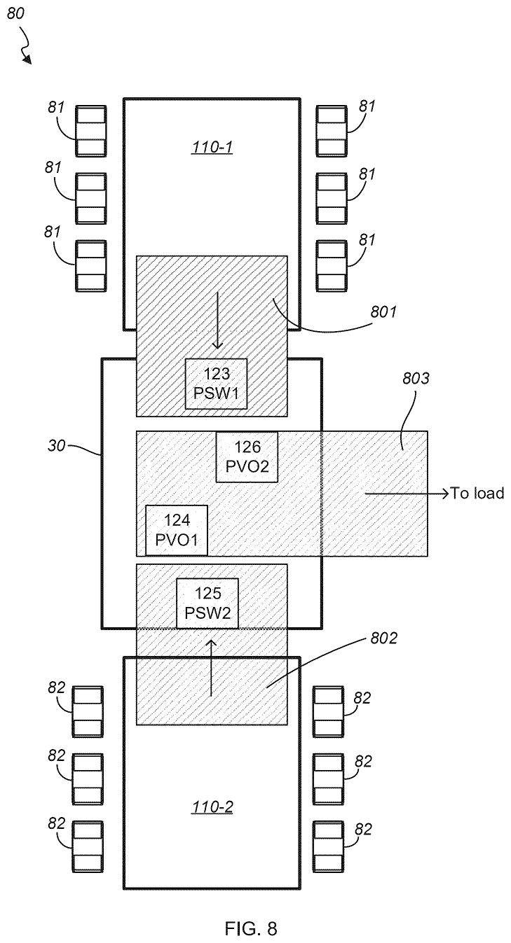

FIG. 8 illustrates a layout 80 of the power converter 100 of FIG. 1 in accordance with an embodiment of the present invention. FIG. 8 illustrates an example connection between the inductor assembly 30 and the power dies 110-1, 110-2. In this compact and efficient layout, the inductor assembly 30 is placed between two power dies 110-1 and 110-2, that is the power dies 110-1, 110-2 are placed on opposite sides of the inductor assembly 30, allowing for reduced component count, improved thermal management, and enhanced overall system performance.

In the example of FIG. 8, an interconnect 801 connects the power die 110-1 to the first end 123 of the winding 302 in the inductor assembly 30 to allow a current flowing from the power die 110-1 to the switching pad PSW1. An interconnect 802 connects the power die 110-2 to the first end 125 of the winding 303 in the inductor assembly 30 to allow a current flowing from the power die 110-2 to the switching pad PSW2. An interconnect 803 connects the second end 124 of the winding 302 and the second end 126 of the winding 303 to provide an output voltage to the load, which allows a current flowing from the inductor assembly 30 to the load. The interconnect may be metal structures, such as copper traces on PCB. The configuration of the inductor assembly 30 makes it possible to place the output pads PVO1 and PVO2 in the middle region, enabling an improved layout and the creation of a more efficient, reliable, and compact power converter.

In one example, various electronic components 81 may be mounted in the vicinity of the power die 110-1, various electronic components 82 may be mounted in the vicinity of the power die 110-2. These electronic components may include resistors, capacitors, diodes and so on, help to filter, regulate, and control the output voltage and current, ensuring reliable and efficient operation of the power converter 100.

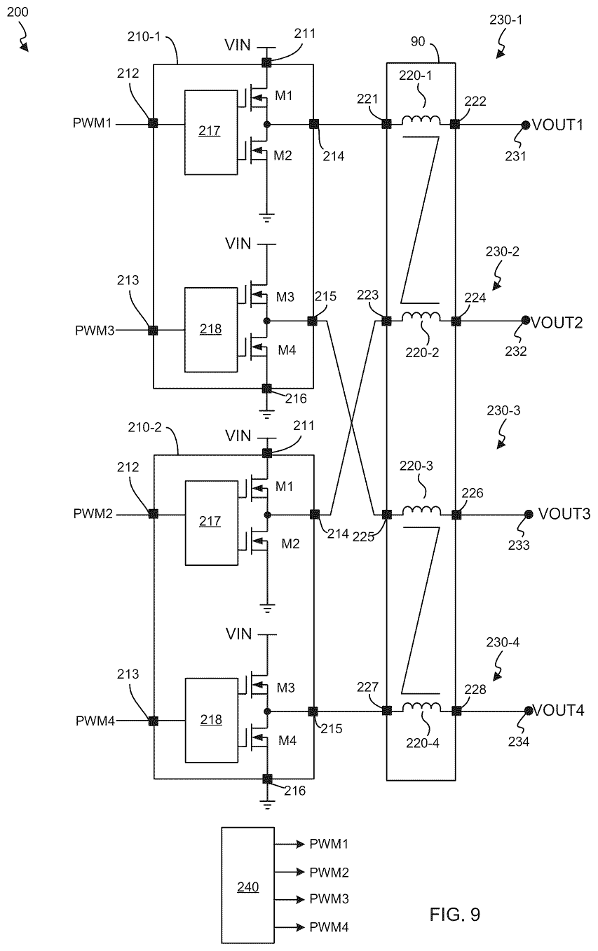

This concept can be extended to more phases, such as the four-phase configuration shown in FIG. 9, allowing for even higher power density and improved efficiency. By using the winding configuration of embodiments of the present disclosure, both inverse coupling and high density can be achieved, enabling the creation of highly efficient and compact multi-phase power converters.

FIG. 9 illustrates a schematic diagram of a power converter 200 in accordance with an embodiment of the present invention. In the example of FIG. 9, the power converter 200 has four phase switching circuits 230 (i.e., 230-1, 230-2, 230-3, 230-4), with each phase switching circuit comprising an output inductor 220 (i.e., 220-1, 220-2, 220-3, 220-4), a pair of switches and corresponding drivers to drive the pair of switches.

In the example of FIG. 9, each of power dies 210 (i.e., 210-1, 210-2) provides two pair of switches (i.e., a first pair of switches including high-side switch M1 and low-side switch M2, and a second pair of switches including high-side switch M3 and low-side switch M4) and two drivers 217 and 218 for two phase switching circuits, allowing for a more compact and efficient design. The switching circuit 230-1 comprises the output inductor 220-1, the pair of switches including the switches M1 and M2 of the power die 210-1, and the driver 217 of the power die 210-1. The switching circuit 230-2 comprises the output inductor 220-2, the pair of switches including the switches M1 and M2 of the power die 210-2, and the driver 217 of the power die 210-2. The switching circuit 230-3 comprises the output inductor 220-3, the pair of switches including the switches M3 and M4 of the power die 210-1, and the driver 218 of the power die 210-1. The switching circuit 230-4 comprises the output inductor 220-4, the pair of switches including the switches M3 and M4 of the power die 210-2, and the driver 218 of the power die 210-2.

Each power die 210 has an input node 211 configured to receive the input voltage VIN, a control node 212 configured to receive a first switching control signal (i.e., PWM1, PWM2), a control node 213 configured to receive a second switching control signal (i.e., PWM3, PWM4), a first switch node 214 configured to provide the output voltage VOUT (i.e., VOUT1, VOUT2) via the corresponding output inductor 220 (i.e., 220-1, 220-2), a second switch node 215 configured to provide the output voltage VOUT (i.e., VOUT3, VOUT4) via the corresponding output inductor 220 (i.e., 220-3, 220-4), and a reference node 216 electrically connected to a reference ground. The output voltages VOUT1-VOUT4 may be connected together and interleaved to generate a multiphase output voltage, which can provide several benefits including improved efficiency, reduced ripple, and increased power density. For example, output voltage nodes 231-234 may be connected together, with each switching circuit 230 providing a phase of a multiphase output voltage. In the example of FIG. 9, each of the switching circuits 230 is a buck circuit. As can be appreciated, each of the switching circuits 230 may also be configured as boost circuit or other types of switching circuit depending on the application.

The output inductors 220-1, 220-2, 220-3, and 220-4 are formed by four windings integrated into an inductor assembly 90 sharing a magnetic core, which can provide several benefits including reduced size, improved efficiency, and increased reliability by allowing the inductors to be more compactly packaged and reducing the overall number of components. The magnetic core may be a single-piece or multipiece core that is made of a magnetic material that is commonly used in magnetic cores. The output inductors 220-1, 220-2 are inversely coupled with each other as a first group of coupled inductors, and the output inductors 220-3, 220-4 are inversely coupled with each other as a second group of coupled inductors.

In the example of FIG. 9, a winding of the output inductor 220-1 has a first end 221 and a second end 222, the first end 221 is electrically connected to the switch node 214 of the power die 210-1, and the second end 222 is electrically connected to the output voltage node 231 to provide the output voltage VOUT1. A winding of the output inductor 220-2 has a first end 223 and a second end 224, the first end 223 is electrically connected to the switch node 214 of the power die 210-2, and the second end 224 is electrically connected to the output voltage node 232 to provide the output voltage VOUT2. A winding of the output inductor 220-3 has a first end 225 and a second end 226, the first end 225 is electrically connected to the switch node 215 of the power die 210-1, and the second end 226 is electrically connected to the output voltage node 233 to provide the output voltage VOUT3. A winding of the output inductor 220-4 has a first end 227 and a second end 228, the first end 227 is electrically connected to the switch node 215 of the power die 210-2, and the second end 228 is electrically connected to the output voltage node 234 to provide the output voltage VOUT4.

A controller 240 generates switching control signals PWM1-PWM4 to drive the power dies 210-1, 210-2 respectively, such that the output voltages VOUT1-VOUT4 are maintained in regulation. Other circuits or components, such as input capacitors, output capacitors, sense circuits, are not shown for clarity of illustration.

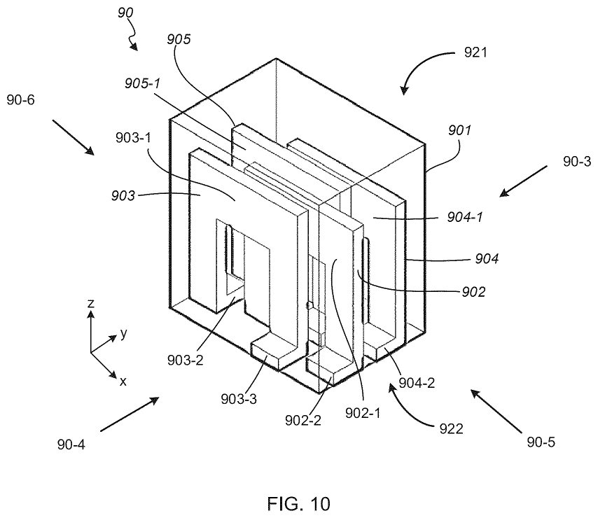

FIG. 10 illustrates a perspective view of the inductor assembly 90 in accordance with an embodiment of the present invention. The inductor assembly 90 has four windings 902-905 which are magnetically coupled together via a magnetic core 901. The winding 902 forms the output inductor 220-1, the winding 903 forms the output inductor 220-2, the winding 904 forms the output inductor 220-3, and the winding 905 forms the output inductor 220-4.

Each of the windings 902-905 has a main body (i.e., 902-1, 903-1, 904-1, 905-1) that are arranged in parallel and perpendicular to a top surface 921 and a bottom surface 922 of the inductor assembly 90. The windings 902 and 903 are partially overlapped with each other, e.g., a main body 902-1 of the winding 902 and a main body 903-1 of the winding 903 are partially overlapped with each other, to create inverse coupling between the windings 902 and 903. The windings 904 and 905 are partially overlapped with each other, e.g., main bodies 904-1 and 905-1 of the windings 904 and 905 are partially overlapped with each other, to create inverse coupling between the windings 904 and 905. In one embodiment, these main bodies 902-1, 903-1, 904-1, 905-1 have an “n” shape, with each extending towards the top surface 921 of the inductor assembly 90.

The winding 902 further includes a portion 902-2 and a portion 902-3 (not visible in FIG. 10) at least partially exposed on the bottom surface 922 of the inductor assembly 90. The portion 902-2 and the portion 902-3 are connected by the main body 902-1. The portion 902-2 extends to form the first end 221 of the winding 902 on the bottom surface 922 of the inductor assembly 90. The portion 902-3 extends to form the second end 222 of the winding 902 on the bottom surface 922. The winding 903 further includes a portion 903-2 and a portion 903-3 at least partially exposed on the bottom surface 922 of the inductor assembly 90. The portion 903-2 and the portion 903-3 are connected by the main body 903-1. The portion 903-2 extends to form the first end 223 of the winding 903 on the bottom surface 922 of the inductor assembly 90. The portion 903-3 extends to form the second end 224 of the winding 903 on the bottom surface 922. The winding 904 further includes a portion 904-2 and a portion 904-3 (not visible in FIG. 10) at least partially exposed on a bottom surface 922 of the inductor assembly 90. The portion 904-2 and the portion 904-3 are connected by the main body 904-1. The portion 904-2 extends to form the first end 225 of the winding 904 on the bottom surface 922 of the inductor assembly 90. The portion 904-3 extends to form the second end 226 of the winding 904 on the bottom surface 922. The winding 905 further includes portions 905-2 and 905-3 (not visible in FIG. 10) at least partially exposed on a bottom surface 922 of the inductor assembly 90. The portion 905-2 and the portion 905-3 are connected by the main body 905-1. The portion 905-2 extends to form the first end 227 of the winding 905 on the bottom surface 922 of the inductor assembly 90. The portion 905-3 extends to form the second end 228 of the winding 905 on the bottom surface 922.

A partially overlapped region between the windings 902 and 903 are used to control the coupling coefficient between the output inductors 220-1 and 220-2. A partially overlapped region between the windings 904 and 905 are used to control the coupling coefficient between the output inductors 220-3 and 220-4. In the example of FIG. 10, the four windings are arranged sequentially from front to back as follows: winding 903, winding 902, winding 905, and winding 904. Different winding placement sequences could also be employed for different applications. This particular order maximizes the partially overlapped region between windings 903 and 902 and the partially overlapped region between the windings 905 and 904, while maintaining a larger separation between a first winding group formed by the windings 902-903 and a second winding group formed by the windings 904-905.

In one embodiment, the portions 902-2 and 904-2 are positioned near one edge of the bottom surface 922, the portions 903-2 and 905-2 are positioned near another opposite edge of the bottom surface 922, and the portions 902-3, 903-3, 904-3 and 905-3 are positioned farther away from edges of the bottom surface 922, e.g., in a middle region of the bottom surface 922. In one embodiment, the portions 902-2, 904-2, 903-3, 905-3 extend towards a side surface 90-4 of the magnetic core 901, and the portions 902-3, 904-3, 903-2, 905-2 extend towards a side surface 90-3 of the magnetic core 901, the side surface 90-3 is opposite to the side surface 90-4.

In one embodiment, the windings 902 and 904 are partially exposed on a side surface 90-5 of the magnetic core 901, the windings 903 and 905 are partially exposed on a side surface 90-6 of the magnetic core 901. The side surfaces 90-5 and 90-6 are opposite to each other. In one embodiment, the windings 902-905 could have the same length, width and height. The length (e.g., along the x-axis shown in FIG. 10) of the windings 902-905 are smaller than that of the magnetic core 901. The height (e.g., along the z-axis shown in FIG. 10) of the windings 902-905 could be same or smaller than that of the magnetic core 901.

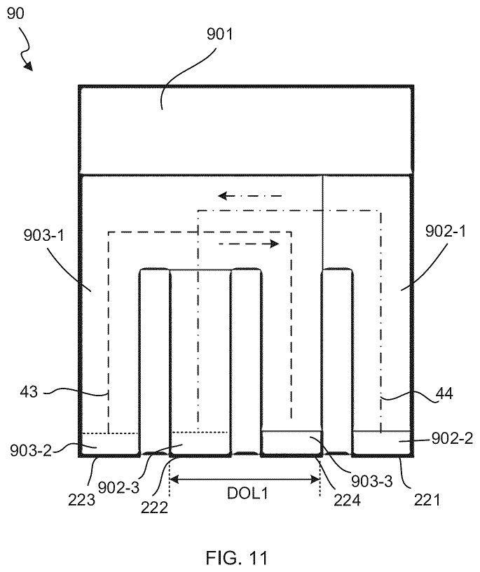

FIG. 11 illustrates a front view of the inductor assembly 90 of FIG. 9 in accordance with an embodiment of the present invention. Because of the relative placement of the windings 902-905, FIG. 11 shows the front-most windings 903 and 902 directly, while the windings 905 and 904 are behind the windings 903 and 902, and are not visible.

To illustrate the current flow, a dotted line 43 shows a current flowing through the winding 903, e.g., flows from the first end 223 to the second end 224 of the winding 903. A dot-dash line 44 shows a current flowing through the winding 902, e.g., flows from the first end 221 to the second end 222 of the winding 902. In the partially overlapped region of the windings 902-903, the main bodies 902-1 and 903-1 are partially overlapped with each other to have inverse current flow, such that a flux generated by the windings 902-903 are reduced. A length DOL1 indicating the partially overlapped region of the windings 902-903 determines the coupling coefficient between them for optimal performance. Specifically, the longer the length DOL1 is, the larger the coupling coefficient; conversely, the shorter the length DOL1 is, the smaller the coupling coefficient.

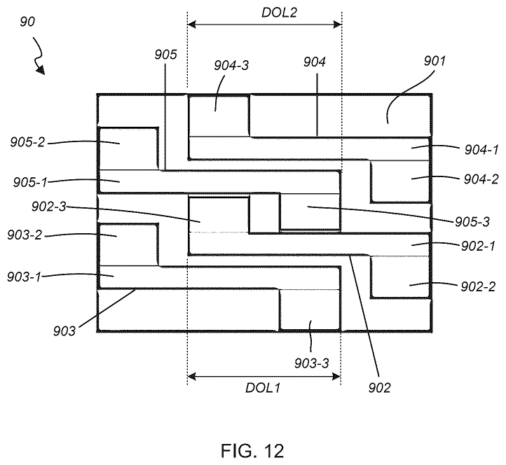

FIG. 12 illustrates a top view of the inductor assembly 90 of FIG. 9 in accordance with an embodiment of the present invention. The length DOL1 indicates the partially overlapped region between the windings 902 and 903. A length DOL2 indicates the partially overlapped region between the windings 904 and 905 which determines the coupling coefficient between the windings 904 and 905.

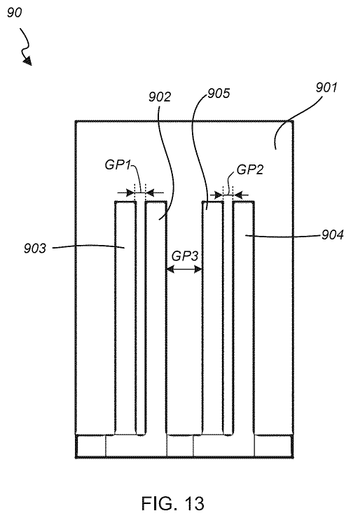

FIG. 13 illustrates a side view of the inductor assembly 90 of FIG. 9 in accordance with an embodiment of the present invention. FIG. 13 shows a gap GP1 between the windings 903 and 902, a gap GP2 between the windings 905 and 904, and a gap GP3 between the windings 902 and 905. In one example, each gaps GP1 and GP2 is less than 0.4 mm.

The gaps GP1 and GP2 should be smaller than the gap GP3 between the first group of the inversely coupled windings (i.e., 902, 903) and the second group of the inversely coupled windings (i.e., 904, 905). The gap GP3 between the windings 902 and 905 is used to decouple different groups of the inversely coupled windings.

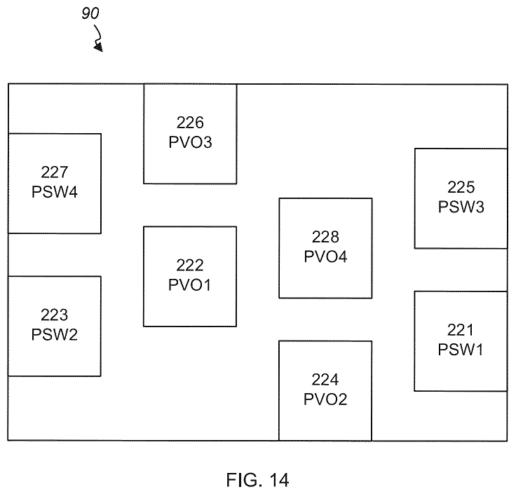

FIG. 14 illustrates a bottom view of the inductor assembly 90 of FIG. 9 in accordance with an embodiment of the present invention. In the example of FIG. 14, the ends 221-228 of the windings 902-905 are on the bottom surface 922 of the inductor assembly 90, playing a crucial role in facilitating current flow and power transmission.

The first end 221 of the winding 902 is electrically connected to the switching pad PSW1, which connects to the switch node 214 of the power die 210-1. The second end 222 of the winding 902 forms or is electrically connected the output pad PVO1, which connects to the output voltage node 231 to provide the output voltage VOUT1. The first end 223 of the winding 903 forms or is electrically connected to the switching pad PSW2, which connects to the switch node 214 of the power die 210-2. The second end 224 of the winding 903 forms or is electrically connected to the output pad PVO2, which connects to the output voltage node 232 to provide the output voltage VOUT2. The first end 225 of the winding 904 forms or is electrically connected to a switching pad PSW3, which connects to the switch node 215 of the power die 210-1. The second end 226 of the winding 904 forms or is electrically connected to an output pad PVO3, which connects to the output voltage node 233 to provide the output voltage VOUT3. The first end 227 of the winding 905 forms or is electrically connected to a switching pad PSW4, which connects to the switch node 215 of the power die 210-2. The second end 228 of the winding 905 forms or is electrically connected to an output pad PVO4, which connects to the output voltage node 234 to provide the output voltage VOUT4.

As shown in FIG. 14, the output pads PVO1-PVO4 are located in the middle region of the bottom surface 922 of the inductor assembly 90 and are not close to the edges anymore. Larger space can be used for each pad, especially the output pads PVO1-PVO4, which is helpful for layout and soldering.

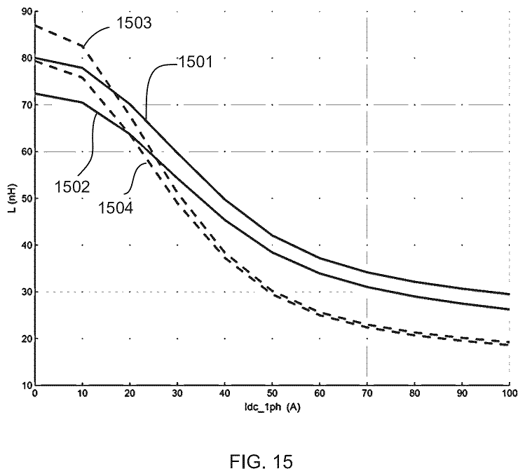

FIG. 15 illustrates inductance curves of the output inductors 220-1 and 220-2 in accordance with an embodiment of the present invention. FIG. 15 shows one example of inductance curves of the output inductors 220-1 and 220-2, and the output inductors 220-3 and 220-4 have similar inductance curves and are not shown for clarity.

A steady-state equivalent inductance curve 1501 shows equivalent inductance profile of the output inductor 220-1 versus the output current at steady state. A steady-state equivalent inductance curve 1502 shows equivalent inductance profile of the output inductor 220-2 versus the output current at steady state. A transient equivalent inductance curve 1503 shows equivalent inductance profile of the output inductor 220-1 versus the output current at transient. A transient equivalent inductance curve 1504 shows equivalent inductance profile of the output inductor 220-2 versus the output current at transient. The steady-state equivalent inductance curves 1501-1502 are generated based on the four phase interleaving operation with 90-degree phase shifted PWM driving signals. The transient equivalent inductance curves 1503-1504 are generated based on in-phase operation, which means that each phase circuits are turned on and off simultaneously.

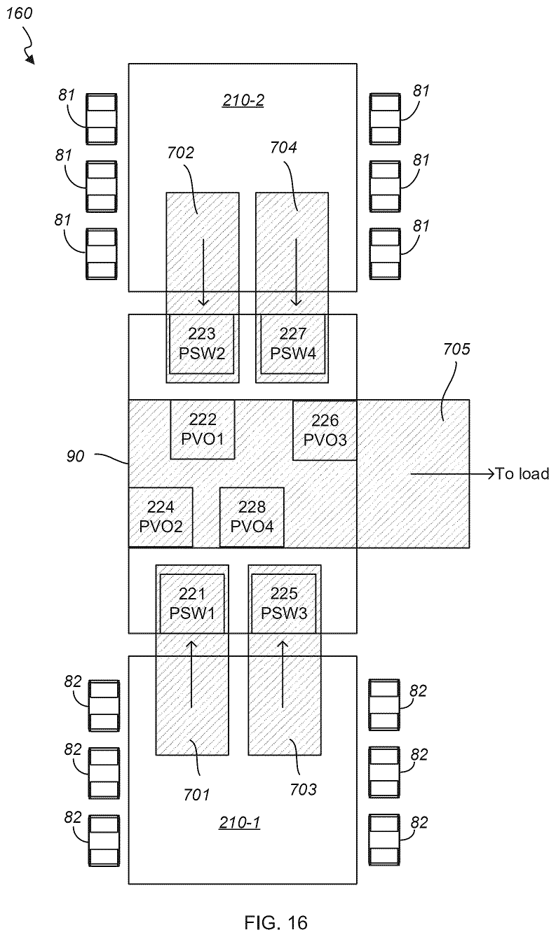

FIG. 16 illustrates a layout 160 of the power converter 200 of FIG. 9 in accordance with an embodiment of the present invention.

The two power dies 210-1 and 210-2 are placed on opposite sides of the inductor assembly 90. The output pads PVO1-PVO4 are at the middle region of the bottom surface 922 of the inductor assembly 90. In the example of FIG. 16, a current flows from the power die 210-1 to the switching pad PSW1 via an interconnect 701, a current flows from the power die 210-2 to the switching pad PSW2 via an interconnect 702, a current flows from the power die 210-1 to the switching pad PSW3 via an interconnect 703, a current flows from the power die 210-2 to the switching pad PSW4 via an interconnect 704. In the example of FIG. 16, the output pads PVO1-PVO4 are electrically connected together, e.g., via an interconnect 705, to provide the output voltage to the load, which allows a current flowing from the inductor assembly 90 to the load.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A power converter, comprising:
an inductor assembly having two windings that share a magnetic core to form coupled inductors, wherein each winding has a main body extending towards a top surface of the inductor assembly, a first portion extending to form a first end at a bottom surface of the inductor assembly, and a second portion extending to form a second end at the bottom surface of the inductor assembly; and
two power dies, wherein each of the power dies comprises a pair of switches that form a switch node electrically connected to the first end of a corresponding winding, and the second end of the corresponding winding is electrically connected to provide an output voltage; wherein
a partially overlapped region between the two windings determines a coupling coefficient between the coupled inductors.

2. The power converter of claim 1, wherein the first ends of the two windings are located at opposite edges of the bottom surface of the inductor assembly, the second ends of the two windings are located at a middle region of the bottom surface of the inductor assembly, and the two power dies are placed on opposite sides of the inductor assembly.

3. The power converter of claim 2, further comprising:
an interconnect connecting the second ends of the two windings together to provide the output voltage.

4. The power converter of claim 1, wherein the main bodies of the two windings are arranged perpendicular to the top and bottom surface of the inductor assembly and partially overlap with each other to create an inverse coupling between the two windings.

5. The power converter of claim 1, wherein the first portion of a first winding and the second portion of a second winding extend towards a first side surface of the magnetic core, the second portion of the first winding and the first portion of the second winding extend towards a second side surface of the magnetic core, the first side surface is opposite to the second side surface.

6. The power converter of claim 1, wherein a gap between the two windings is less than 0.4 mm.

7. A power converter, comprising:
an inductor assembly having four windings that share a magnetic core to form coupled inductors, wherein each winding has a main body extending towards a top surface of the inductor assembly, a first portion extending to form a first end at a bottom surface of the inductor assembly, and a second portion extending to form a second end at the bottom surface of the inductor assembly; and
two power dies placed on opposite sides of the inductor assembly, wherein each of the power dies comprises two pairs of switches, each pair of switches forms a switch node that is electrically connected to the first end of a corresponding winding, and the second end of the corresponding winding is electrically connected to provide an output voltage.

8. The power converter of claim 7, wherein:
a first partially overlapped region between a first winding and a second winding determines a first coupling coefficient between the first winding and the second winding; and
a second partially overlapped region between a third winding and a fourth winding determines a second coupling coefficient between the third winding and the fourth winding.

9. The power converter of claim 8, wherein:
a first end of the first winding is electrically connected to the switch node formed by a first pair of switches from a first power die;
a first end of the second winding is electrically connected to the switch node formed by a first pair of switches from a second power die;
a first end of the third winding is electrically connected to the switch node formed by a second pair of switches from the first power die; and
a first end of the fourth winding is electrically connected to the switch node formed by a second pair of switches from the second power die.

10. The power converter of claim 7, wherein the first ends of the four windings are located at edges of the bottom surface of the inductor assembly, and the second ends of the four windings are located at a middle region of the bottom surface of the inductor assembly.

11. The power converter of claim 10, further comprising an interconnect connecting the second ends of the four windings together to provide the output voltage.

12. The power converter of claim 7, wherein:
the main body of a first winding and the main body of a second winding are arranged perpendicular to the top and bottom surface of the inductor assembly and partially overlap each other, creating inverse coupling between them; and
the main body of a third winding and the main body of a fourth winding are arranged perpendicular to the top and bottom surface of the inductor assembly and partially overlap each other, creating inverse coupling between them.

13. The power converter of claim 7, wherein:
the first and second windings are placed adjacent to each other to form a first group of inversely coupled windings, there is a first gap between the first and second windings; and
the third and fourth windings are placed adjacent to each other to form a second group of inversely coupled windings, there is a second gap between the third and fourth windings.

14. The power converter of claim 13, wherein the first gap and the second gap are smaller than a third gap between the first and second groups of the inverse coupled windings.

15. The power converter of claim 13, wherein each of the first and second gaps is less than 0.4 mm.

16. An inductor assembly for a power converter, comprising:
a magnetic core; and
a first winding and a second winding that share the magnetic core; wherein
each of the first and second windings has a main body extending towards a top surface of the inductor assembly, a first portion extending to form a first end at a bottom surface of the inductor assembly, and a second portion extending to form a second end at the bottom surface of the inductor assembly; and
a first partially overlapped region between the first and second windings determines a coupling coefficient between the first and second windings.

17. The inductor assembly of claim 16, wherein:
the first end of the first winding is electrically connected to a first switch node formed by a first pair of switches;
the second end of the first winding is electrically connected to a first output pad;
the first end of the second winding is electrically connected to a second switch node formed by a second pair of switches; and
the second end of the second winding is electrically connected to a second output pad.

18. The inductor assembly of claim 17, wherein the first ends of the first and second windings are located at opposite edges of the bottom surface of the inductor assembly, and the second ends of the first and second windings are located at a middle region of the bottom surface of the inductor assembly.

19. The inductor assembly of claim 16, further comprising:
a third winding and a fourth winding that share the magnetic core; wherein each of the third and fourth windings has a main body extending towards a top surface of the inductor assembly, a first portion extending to form the first end at the bottom surface of the inductor assembly, and a second portion extending to form the second end at the bottom surface of the inductor assembly; and
a second partially overlapped region between the third and fourth windings determines a coupling coefficient between the third and fourth windings.

20. The inductor assembly of claim 19, wherein:
the first and second windings are placed adjacent to each other to form a first group of inversely coupled windings, and there is a first gap between the main body of the first winding and the main body of the second windings;
the third and fourth windings are placed adjacent to each other to form a second group of inversely coupled windings, and there is a second gap between the main body of the third winding and the main body of the fourth windings; and
the first gap and the second gap are smaller than a third gap between the first and second groups of the inversely coupled windings.
